(19) United States
(12) Patent Application Publication
(10) Pub. No.: US 2019/0110627 A1
(43) Pub. Date: Apr. 18, 2019

(54) FRUIT CUP INFUSER

(71) Applicant: MUNCHKIN, INC., Van Nuys, CA (US)

(72) Inventors: Quinn Michael Biesinger, Los Angeles, CA (US); Thomas E. Birkert, West Hills, CA (US); Mark Gerard Tebbe, Ventura, CA (US)

(21) Appl. No.: 16/216,984

(22) Filed: Dec. 11, 2018

Related U.S. Application Data
(63) Continuation-in-part of application No. 29/617,890, filed on Sep. 15, 2017.
Application No. 29/617,890 is a continuation-in-part of application No. 29/617,859, filed on Sep. 15, 2017.
(60) Provisional application No. 62/629,452, filed on Feb. 12, 2018.

(51) Int. Cl. A47J 19/02; A23L 2/04; A47G 19/22

(52) U.S. Cl. CPC A47J 19/023; A23V 2002/00; A47G 19/22; A23L 2/04

(57) ABSTRACT

An infuser container is disclosed. In an aspect, the container includes a body, a filter arranged with the body to form a first chamber for receiving an infusion substance and a second chamber, a cap engaged with the body, the cap having an extractor extending into the first chamber when the cap is engaged with the body, wherein the extractor is configured to mash the infusion substance to produce an extracted substance when engaging the cap with the body. Thus extraction of liquid from the infusion substance such as fruit can occur concurrently with engaging the cap with the body. In an embodiment, a collar and seal assembly is arranged on the drinking end of the body, which can be removed to add a liquid to the second chamber such that the extracted liquid and the liquid can blend. In another embodiment, the filter includes apertures positioned to trap the extracted liquid in the filter chamber during the securing of the cap. A dual filter system may be implemented such that the collar and seal assembly includes additional apertures that can act to further filter the blended liquid.

### CROSS-REFERENCE TO RELATED APPLICATIONS

This patent application claims the benefit of and right of priority under 35 U.S.C. § 119 to U.S. Provisional Patent Application No. 62/629,452, filed Feb. 12, 2018 entitled “Fruit Cup Infuser,” the contents of which are incorporated by reference as if fully set forth herein. This application also claims the benefit of and right of priority under 35 U.S.C § 120 to Design patent application Ser. No. 29/617,859 filed Sep. 15, 2017 entitled “Fruit Infuser Cup” and U.S. Design patent application Ser. No. 29/617,890 filed Sep. 15, 2017 entitled “Fruit Cup Infuser”, the contents of each of which are incorporated by reference as if fully set forth herein.

### BACKGROUND

### Field

The present disclosure relates generally to spill-resistant containers, and more specifically, to non-spill drinking containers capable of infusing liquids with fruit, herbs, teas, coffees, and a variety of other infusion substances.

### Background

Beverage infusers are devices used in connection with a cup, bottle or container that allow water or another liquid poured into the container to be passed through liquid extracted from a fruit or other infusion substance, to thereby create an infused beverage. The infuser may be used to create juices or fruit drinks, for example, by combining the extracted juice from oranges, lemons, strawberries, or other fruits with water. Different types of infusion substances may be used in various conventional infusing devices including certain vegetables, tea leaves, coffees, and the like. The infuser may also be used to add flavor or otherwise provide a particular essence to the water, to brew the water into a tea or coffee, or to perform flavor-enhancing functions.

Conventional infusers have shortcomings. For one, the user must undergo several steps prior to being able to drink the infused beverage. In a conventional device, for example, a user must complete the actual juice extraction process prior to sealing the container end and blend the liquids.

Another problem with conventional devices is that during the juice extraction step, gravity causes the extracted juice to fall to the drinking end of the container. The user is invariably burdened with the sticky residue from the juice that permeated the drinking end of the inverted container during the initial juicing. Additionally, these conventional devices are easily susceptible to accidental spills and leaks during drinking.

Further exacerbating these problems is the non-uniform nature of the blended liquid-juice solution in existing infusers. When the user adds water, the result is typically a thick juice concentration at a side of the container (such as the container top) where the extracted liquid may consolidate during the extraction, and a contrasting, diluted concentration dominated by water at the other side of the container. The user must then take further steps, if possible, to equalize the distribution of juice in the container.

The present disclosure addresses these and other shortcomings with conventional infusers.

### SUMMARY

Several aspects of infuser containers will be described more fully hereinafter with reference to various aspects of the present disclosure.

In one aspect of the disclosure, a beverage container includes a body, a filter arranged with the body to form a first chamber for receiving an infusion substance and a second chamber, and a cap engaged with the body, the cap having an extractor extending into the first chamber when the cap is engaged with the body, wherein the engaging of the cap with the body causes the extractor to produce an extracted liquid.

In another aspect of the disclosure, a beverage container includes a body, a filter arranged with the body to form a first chamber for receiving an infusion substance and a second chamber, a cap engaged with the body, the cap having an extractor extending into the first chamber when the cap is engaged with the body, wherein the extractor is configured to mash the infusion substance to produce an extracted substance when engaging the cap with the body.

In another aspect of the disclosure, a method of making a liquid infused beverage includes positioning a container in a first position such that a cap face at least partly upward, a filter arranged with a body of the container to form a first chamber for receiving an infusion substance and a second chamber, the cap having an extractor extending into the first chamber when the cap is engaged with the body, inserting an infusion substance into the first chamber; and engaging the cap onto the body which concurrently mashes the infusion substance and extracts a liquid therefrom.

### BRIEF DESCRIPTION OF THE DRAWINGS

Various exemplary embodiments of the infuser of the present disclosure will now be presented in the detailed description by way of example, and not by way of limitation, in the accompanying drawings, wherein:

FIG. 1 is an upper perspective view of an infuser container according to an embodiment;

FIG. 2 is an exploded view of exemplary elements of the infuser container of FIG. 1 according to an embodiment;

FIG. 3 is a side view of the infuser container according to an embodiment;

FIG. 4 is a lower perspective view of the infuser container according to an embodiment;

FIG. 5 is a top cross-sectional view of the infuser container taken along lines A-A in FIG. 3;

FIG. 6 is a bottom view of the infuser container according to an embodiment;

FIG. 7 is a side cross-sectional view taken along lines B-B in FIG. 5 and lines C-C in FIG. 6;

FIG. 8 is a side cross-sectional view taken along lines B-B in FIG. 5 and lines C-C in FIG. 6, according to another embodiment;

FIG. 9 is an upper perspective view of a seal ring being installed into a collar body;

FIG. 10 is an upper perspective view of the collar body in an inverted position and the sealing ring being removed from the collar body;

FIG. 10a is an exploded view of an inner portion of the collar body including the sealing ring and pull tab;

FIG. 11 is a lower perspective view of a lower sealing ring being installed onto a lower portion of the infuser container;

FIG. 12 is a lower perspective view of the lower sealing ring being removed from the lower portion of the infuser container;

FIG. 13 is an upper perspective view of the infuser container oriented in an upside-down position;

FIG. 14 is an upper perspective view of the cap being removed from the infuser container;

FIG. 15 is an upper perspective view of an exemplary first step of a filter being installed into a lower portion of the infuser container;

FIG. 16 is an upper perspective view of a second step of the filter being installed into position;

FIG. 16a is an exploded view of an indexing portion of the structure in FIG. 16;

FIG. 17 is an upper perspective view of the infuser container with fruit disposed in the filter;

FIG. 18 is a side view of the infuser container of FIG. 17

FIG. 19 is an upper perspective view of the cap being lowered onto a lower portion of the infuser container

FIG. 20 is a side view of the cap being fastened onto the infuser container;

FIG. 21 is a right-side up, upper perspective view of the collar assembly being removed from the infuser container;

FIG. 22 is an upper perspective view of a liquid added into the infuser container;

FIG. 23 is a side view of the collar assembly being fastened to the infuser container.

FIG. 24 is a view of the infuser container in use; and

FIG. 25 is a flow diagram of an exemplary method of creating a beverage using the infuser container.

### DETAILED DESCRIPTION

The detailed description set forth below in connection with the appended drawings is intended to provide a description of various exemplary embodiments of infusers and related structures and is not intended to represent the only embodiments in which the invention may be practiced. The terms “exemplary” and “example” used throughout this disclosure mean “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be simplified or omitted entirely, in order to avoid obscuring the various concepts presented throughout this disclosure.

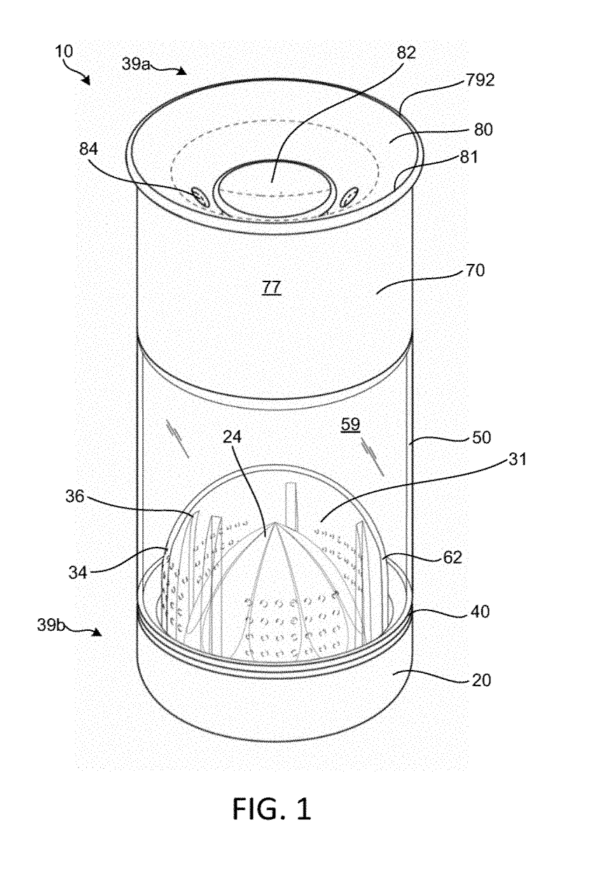

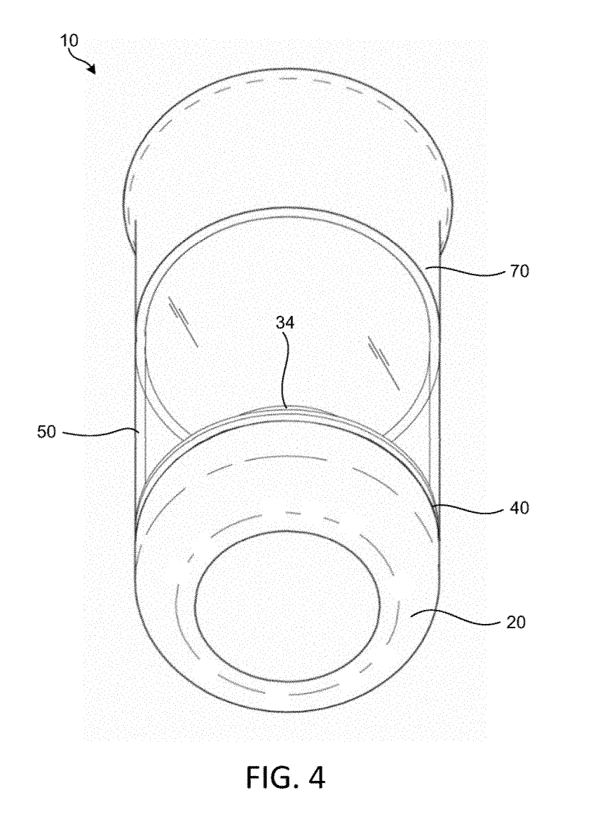

FIGS. 1-8 generally illustrate various aspects of a beverage infuser or container. While the embodiments discussed herein include infusing fruit liquids and essences, it will be appreciated that the beverage infuser herein may in various embodiments be capable of infusing a wide variety of infusing substances including, without limitation, fruits, vegetables, herbs, coffees, teas, spices, human-prepared or processed food items and other infusion substances. In addition, while in some embodiments the beverage infuser may be configured to extract a juice or other liquid from an infusion substance such as a plurality of strawberries and blend the extracted juice with water, in other embodiments a user may add a different or additional liquid beyond water in which the extracted liquid or substance is mixed, and the resulting beverage can be enjoyed by the user.

In an aspect of the disclosure, a spill-resistant infuser container enables a user to infuse a liquid without creating the sticky residue or mess typical of conventional containers. The infuser container includes a body that can be engaged at a lower end to a cap, with an extractor coupled to the cap for mashing a fruit or other infusion substance contained in a chamber of a filter when the cap is engaged with the body and when the container is initially placed in an inverted position. It should be understood that the inverted position need not require that the container be precisely vertical; rather, the container need only be oriented to enable proper use of the infuser and its structures as described herein. Similarly, when the infuser is in the non-inverted or upright position as described herein, such position does not require that the container be precisely vertical in that orientation. Rather, the non-inverted position may include the container being tilted at a relative angle, e.g., when the table on which the container sits is not uniformly horizontal, or a user tilts the container to drink therefrom.

The filter may be arranged between the cap and the lower end of the body for holding the infusion substance, and for allowing the extracted liquid to flow into the remainder of the body and to blend evenly with an infused liquid when the container is returned to an upright position. The user can in various embodiments produce the resulting beverage with a well-blended and generally even concentration, in contrast to the undesirable concentration gradients that are a common artifact of conventional infusers.

In another aspect of the disclosure, the body further includes an upper end configured to couple to a collar and seal assembly for allowing a user to drink from the container in a spill-free manner by using the mouth to apply mild suction to an upper edge of the collar and seal. The collar and seal assembly can also be removed to add water or another infuser liquid. Particularly where the user is a small child but otherwise applicable in general, the user can consume the beverage in the container free of worry over leaks and accidental spills using the collar and seal assembly as described further herein.

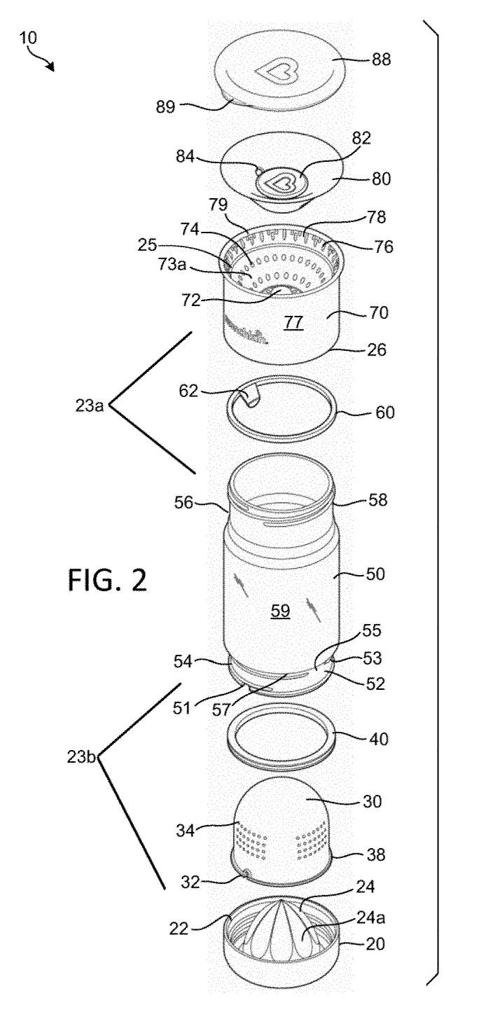

Accordingly, in one embodiment such as shown in FIG. 2, an infuser 10 includes a body 50. The body 50 includes a main portion 59, an upper portion 56, and a lower portion 52. The lower portion 52 includes a lower fastening mechanism 54, which may be a set of threads, and a seal ridge 53 for retaining a lower sealing ring 40. When the infuser 10 is assembled, the lower portion 52 can be engaged with a cap 20 via elements of a lower container interface 23b. The cap 20 may be coupled to an extractor 24 and may include internal threads 22 for twisting onto threads 54 of the lower portion 52 of the body 50. The filter 30 may be secured within the lower portion 52 and within part of the main portion 59 of body 50 to create separate chambers such that a first chamber 31 within the filter 30 is available to hold an infusion substance 95, and a second chamber 37 may include a remaining portion of the body 50 capable of holding liquid when the infuser 10 is closed. The filter 30 may include a pair of indexing protrusions 32 that can be seated in corresponding indexing gaps 51 of the lower portion 52 of the body 50 to prevent unwanted rotation of the filter 30 when the cap 20 is engaged with the lower portion 52. The filter 30 may further include an array of apertures 34 positioned to maintain an extracted liquid 93 within the filter until the infuser 10 is subsequently inverted for adding an infuser liquid 96 to blend with the extracted liquid 93 or substance. For purposes of this disclosure, the terms “extracted liquid” and “extracted substance” can be used interchangeably and may refer either to a liquid (such as, for example, a juice) or, in the appropriate case, a substance (such as, for example, extracted residue from tea leaves).

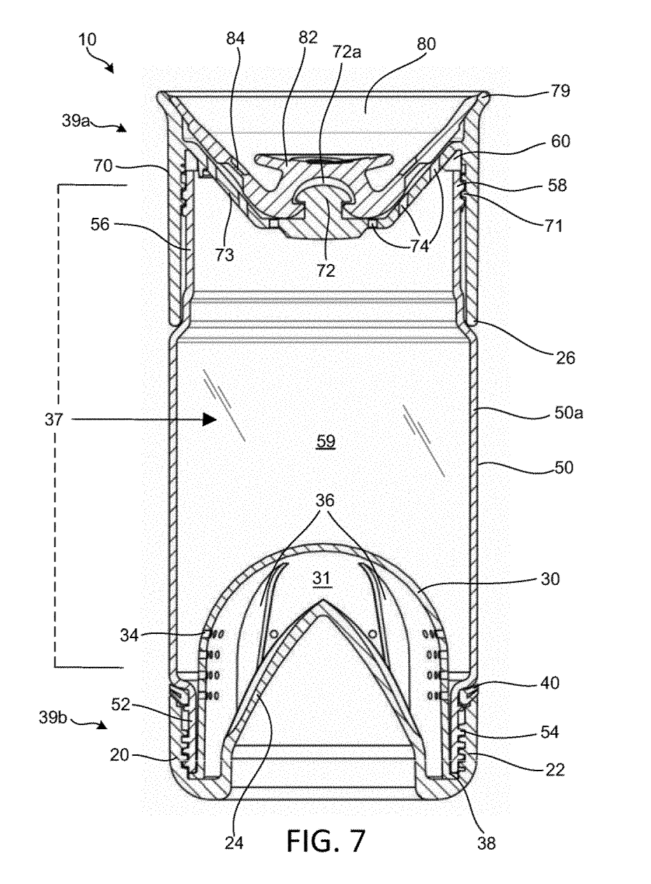

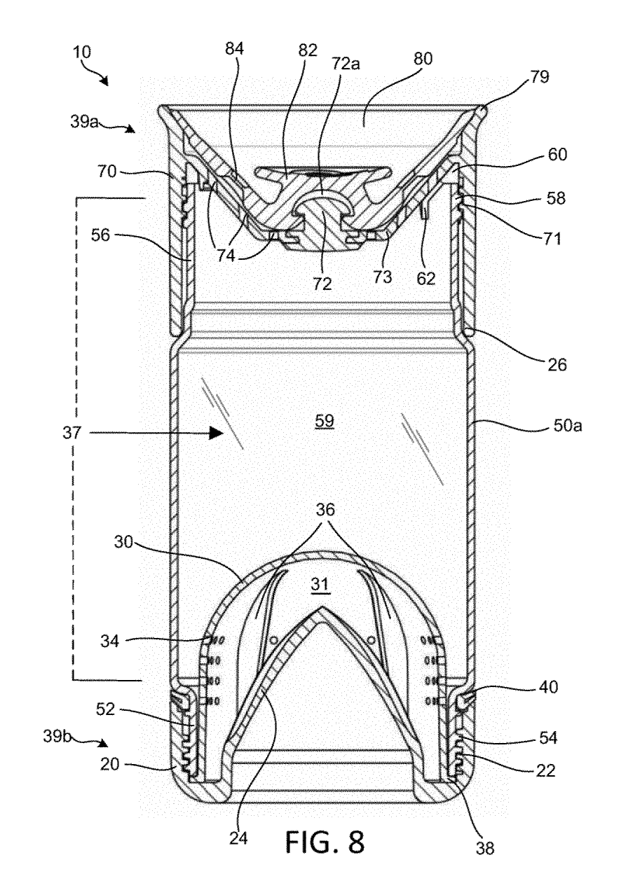

The upper portion 56 includes upper fastening mechanism 58, which may be a set of threads. The upper portion 56 can be coupled to a collar and seal assembly 70 via certain elements used in an upper container interface 23a (FIG. 2). The collar and seal assembly 70 includes a collar body 77 and a seal 80. A top of the collar body 77 may include (i) an upper edge 79 that extends around the perimeter of collar body 77, and (ii) an upper surface 73a defined by an area within a circular edge 25. The upper surface 73a is part of the upper wall 73 of collar body 77 (see, e.g., FIGS. 7-8).

The upper surface 73a of wall 73 may include, or may be coupled to, a projection 72. Projection 72 can be shaped to connect the collar body 77 to the seal 80 via a corresponding recess 72a (FIGS. 7-8) into which projection 72 is inserted to cause the seal 80 to fit snugly over the upper surface 73a of upper wall 73 of collar body 77 to thereby form the collar and seal assembly 70 when the infuser 10 is assembled. Collar body 77 may further include a lower edge 26 around its perimeter. An upper sealing ring 60 having a pull tab 62 can be inserted within the lower edge 26 into an inner portion 99 (FIGS. 10, 10a) of the collar body 77. The side walls 100 of collar body 77 may also include a collar fastening mechanism 71, such as a set of complementary threads, for engaging with the threads of upper fastening mechanism 58 of upper portion 56. Using the threads of the collar fastening mechanism 71 and upper fastening mechanism 58, the collar and seal assembly 70 can be coupled to body 50 by a user's action of screwing the collar and seal assembly 70 onto the upper fastening mechanism 58 of upper portion 56.

The upper surface 73a of the upper wall 73 of the collar body 77 further includes a series of fluid channels 74 that extend from the upper surface 73a of the upper wall 73 to a second chamber 37 of infuser 10 via inner portion 99 of the collar body 77. In an embodiment, the fluid channels 74 may include holes in wall 73 of collar body 77. The fluid channels 74 enable the blended beverage 98 in infuser 10 to flow from the second chamber 37 via the inner portion 99 of collar body 77 through the fluid channels 74, to upper surface 73a underneath the seal 80. From the upper surface 73a, the fluid can then be selectively channeled through a portion of a seal 80 subjected to a suction force by a user drinking from upper edge 79 of collar body 77 and from an adjacent portion of the overlying seal 80. That is, the portion of the seal 80 temporarily opens relative to the upper surface 73a to allow controlled fluid flow when the suction force is applied, and closes when the suction force is stopped as the user stops the drinking action.

The upper surface 73a of upper wall 73 of collar body 77 further includes a series of vertical ridges 76 around the perimeter of the upper surface 73a adjacent upper edge 79, and a series of spaces 78 between the vertical ridges 76. When a user creates a region of suction at the relevant portion of the seal 80 and the upper edge 79 of the collar body 77 to drink from the infuser 10 as described above, the vertical ridges 76 in that region help enable the beverage to flow from the second chamber 37, through fluid channels 74, along the upper surface 73a, and through the spaces 78 adjacent the vertical ridges 76 to be received by the drinking user. In other embodiments, the seal 80 may be used without the vertical ridges 76 and spaces 78 as shown, or it may use alternative structures.

The fluid channels 74 can act as a second set of filters to further refine the quality of the infused beverage 98 that originated from the apertures 34 of filter 30. In still another aspect of the disclosure, the collar and seal assembly 70 provides a spill resistant feature by enabling the seal 80 to immediately close back over the upper surface 73a after a user stops exerting a drinking force, thereby preventing further fluid leaks or spills out of infuser 10.

It is noted that the embodiments shown include a generally cylindrical-shaped infuser 10. However, infuser 10 need not take on a cylindrical shape, and a wide variety of possible shapes of infuser 10 may be possible without departing from the spirit and scope of the present disclosure. For example, and without limitation, infuser 10 may be shaped to resemble a simple cup or glass, a thermos, coffee mug, pouring container, and the like. The infuser 10 may also have a unique ornamental shape. The infuser 10 can alternatively be any prismatic, hexagonal, rectangular, or another symmetric or asymmetric geometric shape.

Referring to one or more of FIGS. 1-8, the spill-resistant or spill free infuser 10 is disclosed (see, e.g., FIG. 2). The infuser 10 may generally include the body 50, which in the embodiments shown is transparent and is capable of holding a volume of liquid, for example, in its first chamber 31 and second chamber 37. The infuser 10 may further include the collar and seal assembly 70 coupled to the upper portion 56 of the body 50. Collar and seal assembly 70 may include the collar body 77 and the seal 80 attached to the collar body 77. In some embodiments, collar and seal assembly 70 may include a plurality of discrete elements, such as shown in FIG. 2 and described in part above. In other embodiments, collar and seal assembly 70 may be a single integrated unit. In still other embodiments, collar and seal assembly 70 may constitute two or three major components. A wide variety of configurations of the collar and seal assembly 70 may be possible. In various embodiments, the collar and seal assembly 70 may serve as a lid—namely, to contain a liquid in body 50. The collar and seal assembly 70 may also be removable to enable the user to add water or liquid 96 to the body 50 to blend the added liquid 96 with an extracted liquid 93. The collar and seal assembly 70 may also have a user-friendly edge, spout, or other structure that enables a user to drink the infused beverage 98 directly from the container. In some embodiments, the collar and seal assembly 70 may be a simple pop top or single piece of material configured to fit over the body 50.

Seal 80 may be coupled to collar body 77 and may include the seal pull tab 82 and optional one-way air valves 84. One-way air valves 84 may operate as a uni-directional conduit to pass excess carbonation, gasses or air out of the infuser 10 to reduce pressure and accommodate more room for liquid in body 50. Seal pull tab 82 may enable a user to remove the seal 80 to expose the upper surface 73a of the upper wall 73 of collar body 77 (FIGS. 2, 7, 8). The exploded view of infuser 10 in FIG. 2 discloses a lid 88 that can be secured over the collar and seal assembly 70 to provide an additional seal for infuser 10. Lid 88 includes pull tab 89 to enable a user to easily remove the lid 88 to access the beverage 98.

FIG. 2 further shows an example of the interior of collar body 77. The wall 73 of collar body 77 includes a plurality of fluid channels 74 generally arranged within circular edge 25 (FIG. 2) of the upper surface 73a of collar body 77. In an embodiment, circular edge 25 represents a gradient in the upper surface 73a outside of which the angle of inclination closer to the edge 79 becomes steeper. Separately, the plurality of small vertical ridges 76 are disposed outside the circular edge 25 and adjacent the upper edge 79 of collar body 77. The plurality of vertical ridges 76 protrude slightly upward to form the spaces 78, which are also disposed about the periphery adjacent the upper edge 79 of collar body 77 and outside circular edge 25. It will be appreciated by those skilled in the art upon review of this disclosure that these features, including the circular edge and the relative angles, etc., may vary and that alternative or additional features may be equally suitable for use in any number of different configurations.

In the embodiment shown, both the fluid channels 74 and spaces 78 are selectively used to enable fluid flow from body 50 when the user engages the lips and mouth against the upper edge 79 of the collar body 77 and against a portion of the seal 80 to drink from infuser 10. The vertical ridges 76 also can create a ledge against which the seal 80 can rest to help enable the seal 80 to fit snugly against the collar body 77 when the user is not drinking and the infuser 10 is closed.

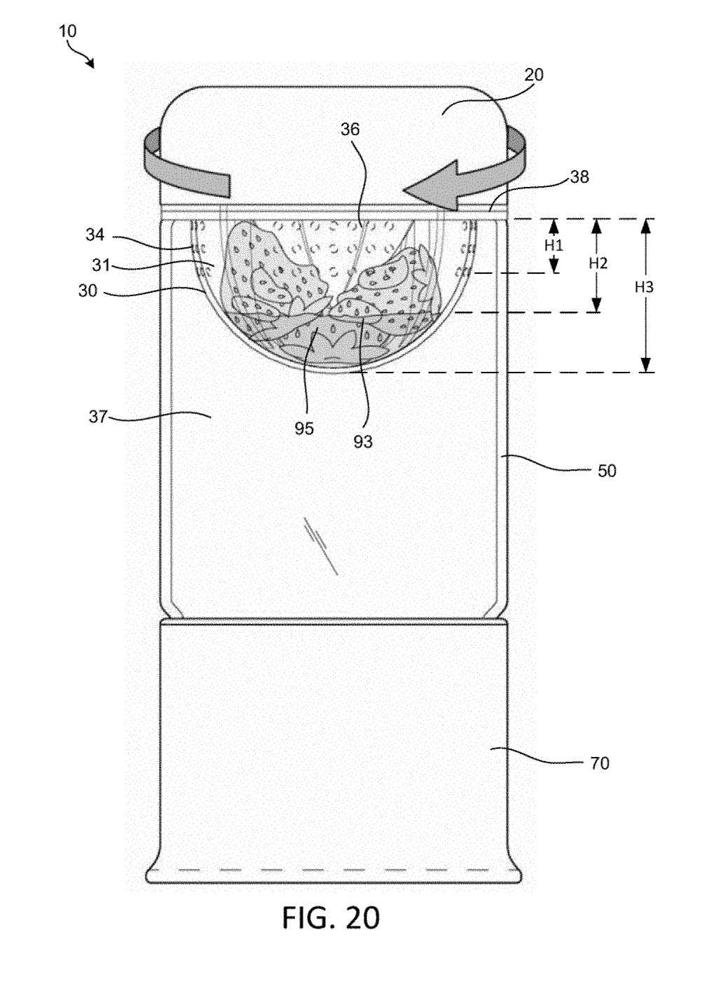

Accordingly, in another aspect of the disclosure, a double-filter mechanism is disclosed such that the extracted liquid or substance is filtered twice prior to exiting the infuser 10 for consumption. The first and principal filter 30, described in more detail below, includes a structure that, when arranged with the body 50, includes a chamber 31 that holds the infusion substance 95 (FIG. 20) and includes a plurality of apertures 34 that act as the first filter mechanism after the infusion substance 95 is mashed to provide an extraction substance or an extracted liquid 93. Subsequently, near the end of the infusion process when the extracted liquid 93 or substance passes through apertures 34 of the first filter 30 and blends with water 96 or another liquid added by a user, the resulting blended liquid (which may include pulp, residue from tea leaves, etc.) exits through the fluid channels 74 and flows through selected ones of the spaces 78 (depending on the regions of the upper edge 79 of the collar body and the seal 80 from which the user is drinking) before being consumed by the user. Fluid channels 74 can be configured to be any appropriate size, depending on the desired amount of filtering. Thus, the beverage 98 in accordance with this aspect of the disclosure is double-filtered. As a result, the infused beverage may be more finely filtered than the single filtering systems of conventional infusers.

With continued reference to FIG. 2, a center interior of collar body 77 includes projection 72. In this embodiment, projection 72 is formed to mate with a recess 72a (see FIG. 7) on the bottom of seal 80 to provide a further sealing force to the collar and seal assembly 70.

FIGS. 7 and 8 show a cross-sectional view of seal 80 having a recess 72a mated with projection 72. As noted above, the collar and seal assembly 77 may include a variety of different implementations and need not be restricted to the specific configuration identified herein.

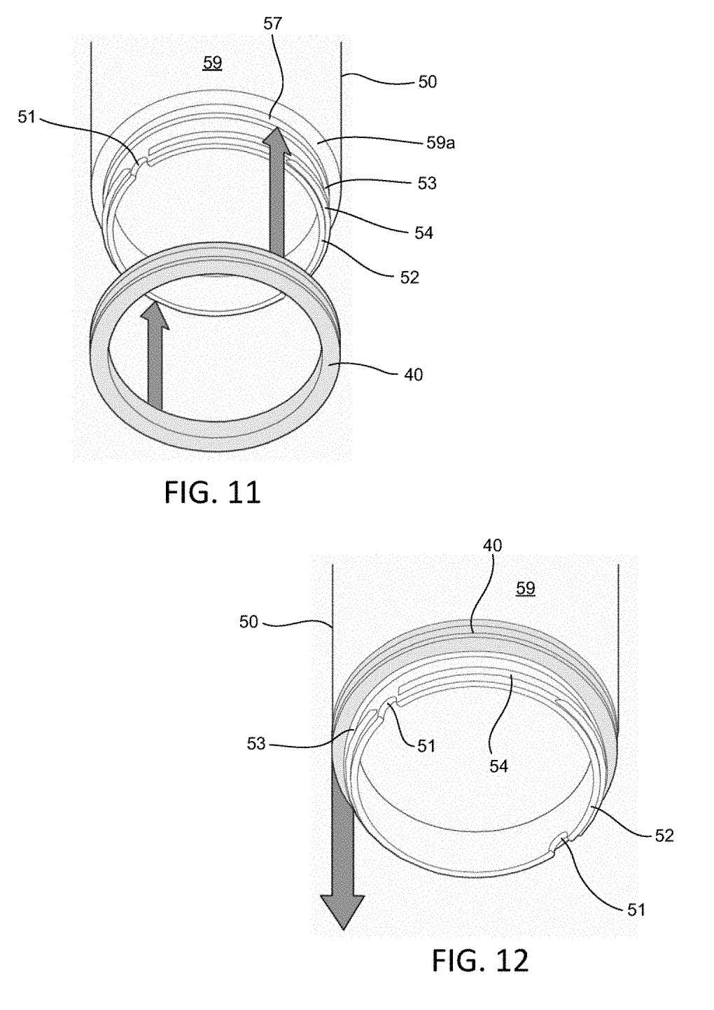

As more clearly shown in FIGS. 11 and 12, the lower portion 52 of body 50 may include a fastening mechanism 54 (which may include, for example, a set of threads) onto which another structure (cap 20) can be fastened as described further below.

Referring generally to FIGS. 1-8, at or near a base of the body 50 is a filter 30 (see FIGS. 2, 3, 7). Filter 30 may include in these embodiments a dome-like structure that resides near the lower portion 52 of body 50 of infuser 10 and that houses a plurality of apertures 34 (FIGS. 1-3, 5, 7, 8). Filter 30 may be coupled to or permanently integrated with either lower portion 52 of body 50 or alternatively, with juicer cap 20. In the embodiment shown, filter 30 is arranged between body 50 and cap 20 and, while filter 30 is functionally integrated with these elements as described below, filter 30 can be a separate unit from these elements, which may be advantageous, e.g., to facilitate cleaning of filter 30 after use. In an embodiment, when the filter 30 is arranged with the body 50, the body 50 includes (i) a first chamber 31 in an interior of the filter 30, and a second chamber 37 that extends through part or all of the remainder of the body 50 and from which a user can add and blend liquid with the extracted liquid 93, and also from which the user can drink. In the embodiment shown in FIGS. 7 and 8, the second chamber 37 is generally defined by the region bordered by the filter 30, the upper surface 73a of upper wall 73 of collar body 77, and the walls 50a of body 50.

An extractor 24 may protrude into the filter 30 to define one of the boundaries of the first chamber 31 when the infuser 10 is closed. In an embodiment, extractor 24 is permanently affixed to cap 20. In other embodiments, extractor 24 may be affixed to cap 20 in operation but may be removable. The extractor 24 and cap 20 can be separate structures or they can be one integrated structure. At a base 39b of infuser 10 is cap 20. Cap 20 is a structure that seals a lower portion of the infuser 10 or body 50 when the infuser 10 is in use, e.g., for drinking. Cap 20 may in some embodiments provide a secure connection for filter 30 and extractor 24 (e.g., FIG. 7, 8) when the cap 20 is fastened to the lower portion 52 of the body 50. These elements are described further below.

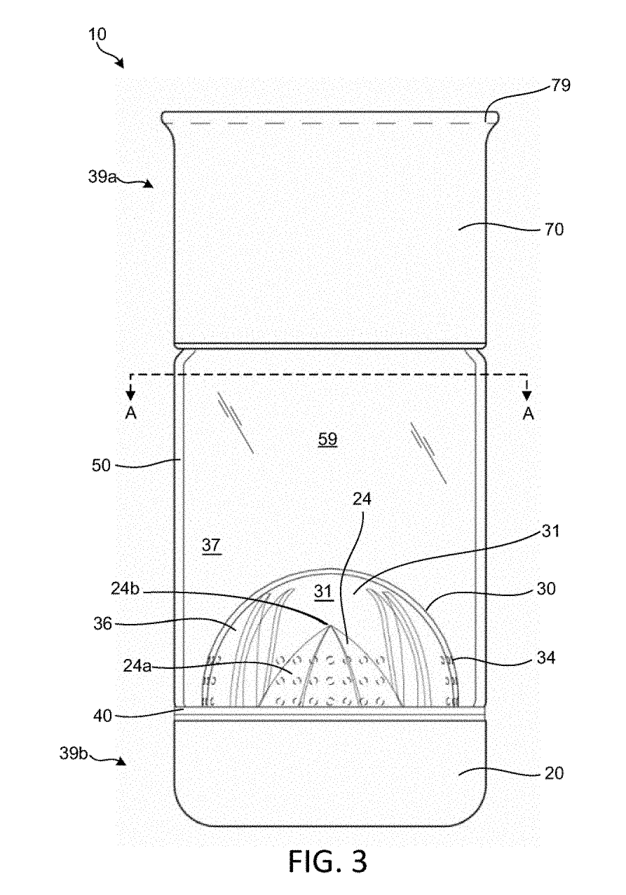

Collar body 77 (FIGS. 1, 2, 4) of collar and seal assembly 70 may include upper edge 79 disposed around the upper perimeter of collar body 77. Seal 80 is arranged over upper surface 73a of collar body. In various embodiments, such as shown in FIGS. 1 and 3, the upper edge 79 of collar body 77 may partially flare out from collar body 77 about the circumference of collar body 77 such that the collar and seal assembly 70 is slightly wider at the top. As shown best in FIG. 1, the outer contour 81 of seal 80 coincides with the shape of the upper edge 79 of collar body 77 such that a snug fit can be achieved. The shape of seal 80 consequently facilitates proper sealing of collar body 77.

The body 50 includes a main portion 59 as shown in FIGS. 1-4, 7 and 8, which may resemble in some embodiments a canister-like container assembly for holding a beverage. The body 50 may also include an upper portion 56 and a lower portion 52, as shown for example in FIGS. 2, 7, 8. The body 50 in these embodiments includes an upper and lower portions 56 and 52, respectively, that are radially narrower than the main portion 59. It should be understood that this need not be the case in practice, however, and that the upper and lower portions 56, 52 of the body 50 can be any suitable shape or size in relation to the main portion 59. In some embodiments, upper and lower portions 56, 52 have the same size and shape as body 50 or are larger. In general, upper and lower portions 56, 52 include fastening elements (described further below) to enable fastening of the collar and seal assembly 70 on the drinking end, and fastening of the cap 20 on the container bottom.

The embodiments in FIGS. 2, 7, 8 and others illustrate that the body 50 can be generally cylindrical in shape. In other embodiments, the body 50 may be another shape. In still other embodiments, the sizes and shapes of body 50, collar and seal assembly 70, and cap 20 may differ from the embodiments shown in the various drawings, without departing from the scope of the disclosure. As noted above, the body 50 (or the main portion 59 of body 50) may be transparent to allow a user to view the fluid within. As is evident from the embodiments in FIGS. 1-4, 7 and 8, the body 50 may occupy an appreciable percentage of infuser 10, although this need not be the case.

Referring back to the exploded version of infuser 10 in FIG. 2, the upper portion 56 of body 50 may include upper fastening mechanism 58. In the embodiment shown, upper fastening mechanism 58 includes a set of threads for receiving a structure that can be secured over the threads and onto upper portion 56. In other embodiments, upper fastening mechanism 58 may be any other suitable fastening mechanism including, for example, latches, interlocking tabs, slidable protrusions, and the like.

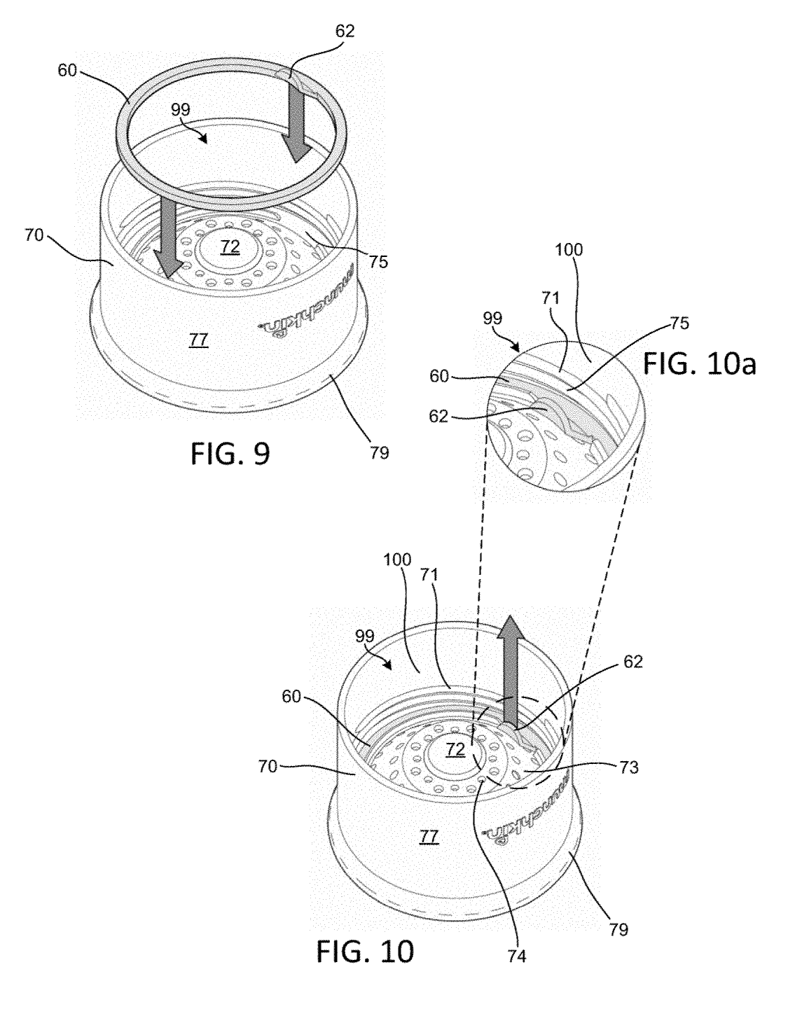

FIG. 9 shows upper sealing ring 60. Because the collar and seal assembly 70 attaches to the upper portion 56 of body 50 in which liquid is held, it may be beneficial in these embodiments to provide upper sealing ring 60 between collar body 77 and upper portion 56 to contain the liquid. FIGS. 9-10 are upper perspective views of upper sealing ring 60 being installed and removed, respectively, into and from collar body 77 of collar and seal assembly 70. Referring to FIG. 9, the collar and seal assembly 70 is shown inverted relative to FIG. 2, such that upper edge 79 of collar body 77 is down and the inner portion 99 of collar body 77 that attaches to upper portion 56 of body 50 is visible. From this view the opposite side of the projection 72 (i.e., the element that mates with recess 72a on the bottom of seal 80) is visible, as are the fluid channels 74 that enable fluid passage between body 50 and upper surface 73a (see FIG. 2). As shown by the vertical arrows, upper sealing ring 60 may be installed into an upper ridge gap 75 located between the collar body 77 and (when the collar and seal assembly 70 is in place on the container) an upper portion 56 of body 50.

Referring to FIGS. 10 and 10a, the upper sealing ring 60 is in its place in upper ridge gap 75 (obscured from view) such that when collar body 77 is subsequently fastened to the upper portion 56 of body 50, the upper sealing ring 60 helps prevent liquid in the body 50 from escaping through any small gaps that may be present between the upper portion 56 and collar body 77, thus securing the drinking end 39a (FIGS. 1, 3, 7, 8) of infuser 10.

Referring back to FIG. 2, the lower portion 52 of body 50 may include a lower fastening mechanism 54. Similar to the upper fastening mechanism 58, the lower fastening mechanism 54 may in various embodiments include different fastening structures such as latches, interlocking tabs, slidable protrusions, and the like. In the embodiment shown, fastening mechanism 54 includes a set of threads.

The lower portion 52 may also include seal ridge 53. The seal ridge 53 may be a radially-raised member of lower portion 52 that at least partially encircles lower portion 52 to accommodate placement of a lower sealing ring 40 in a recessed area 57 between a lower ridge 59a (FIG. 11) of main portion 59 and the seal ridge 53 of lower portion 52. Seal ridge 53 may also have a ridge gap 55 (FIG. 2) to allow a user to more easily remove the lower sealing ring 40 from the seated position illustrated in FIG. 12. In an exemplary embodiment, the ridge gap 55 may be an indentation or vacant space on lower portion 52 in which the seal ridge 53 does not extend all the way radially around lower portion 52. Ridge gap 55 may consequently leave a small space for a user's finger to remove lower sealing ring 40. As also shown in FIGS. 2, 11 and 12, the lower portion 52 may also include an indexing gap 51 disposed therein. Seal ridge 53 is also shown in FIGS. 11-12. The raised circumferential area of seal ridge 53 creates a corresponding circumferential gap 57 (FIG. 11) between the seal ridge 53 and the lower ridge 59a of main portion 59 into which lower sealing ring 40 can be placed. The arrows of FIG. 11 show that the lower sealing ring 40 in this embodiment is placed in the gap 57 located between lower ridge 59a and seal ridge 53.

FIG. 11 is a lower perspective view of the lower sealing ring 40 prior to installation into its place in lower portion 52 of the body 50 of infuser 10. Similarly, FIG. 12 is a lower perspective view of the lower sealing ring 40 in its place and prior to removal from the lower portion 52 of infuser 10.

FIG. 12 shows the lower sealing ring 40 in place between main portion 59 and seal ridge 53 of lower portion 52 of the body 50, wherein gap 57 and ridge 59a are obscured from view by the installed lower sealing ring 40. The down arrow in FIG. 12 shows that the lower sealing ring 40 may be removed, such as by using the ridge gap 55 (FIG. 2) as discussed above.

Referring back to FIG. 3, a side view of the infuser 10 is shown according to an embodiment. The infuser 10 in FIG. 3 illustrates lower sealing ring 40 installed on the lower portion 52 of body 50 adjacent cap 20, with cap 20 being positioned underneath lower sealing ring 40. The lower sealing ring 40 may be positioned such that, in the installed position, cap 20 is biased against the lower sealing ring 40. This bias may create an effective seal on the base 39b of the infuser 10 to prevent leakage.

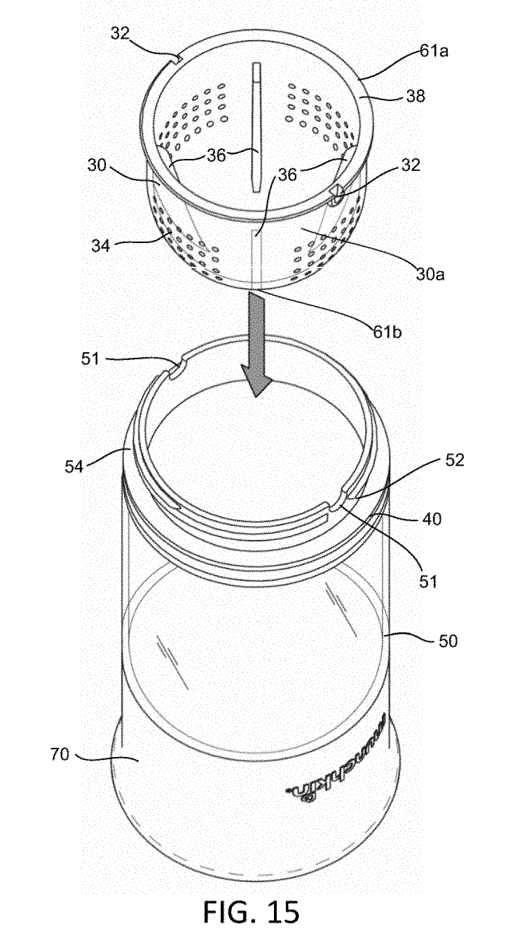

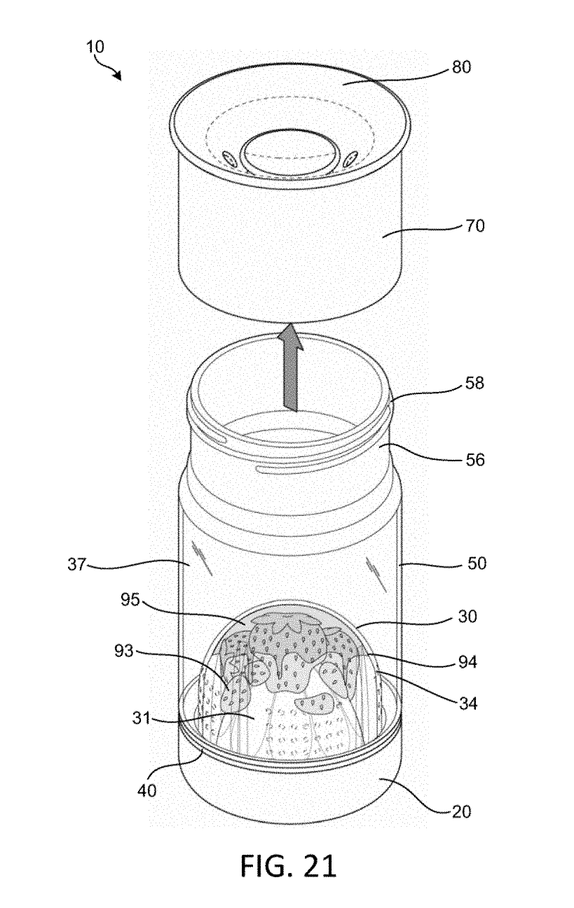

The infuser 10 may also include the filter 30, shown in various figures as installed in the infuser 10, and illustrated in isolation in the perspective views of FIGS. 2 and 15. Filter 30 may incorporate a variety of geometries. In the embodiments shown, filter 30 is a generally dome-like structure terminating at one end 61a in the shape of a cylinder and terminating at the other end 61b as the high point of a semi-circular dome. The cylindrical-shaped end may include ridge 38 extending around its circumference. The filter 30 may also include at least one indexing protrusion 32 for coupling with the body 50 as shown in FIGS. 2 and 15-17 and described in greater detail below. When in the installed position (as shown, for example, in the cross-sectional views of FIGS. 7-8 and in the perspective views of FIGS. 21-23), the filter 30 may in an embodiment define the first chamber 31 in which an infusion substance may be present during use of infuser 10, and the second chamber 37 which may include the remaining available fluid volume of infuser 10.

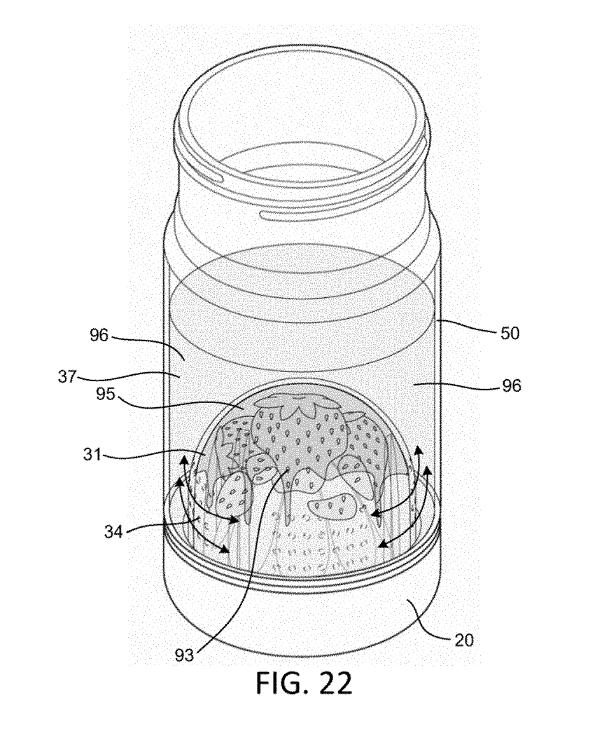

Referring back to FIG. 2, the filter 30 may include a plurality of apertures 34 across its surface (see also FIGS. 3, 5, 7, 8, 15-23). The apertures 34 allow fluid communication (as shown by the arrows in FIG. 22) of extracted liquid 93 or substances inside the first chamber 31 of the filter 30 with liquid 96 added into the body 50. Although shown in the various embodiments as an array or matrix of apertures 34 disposed around a circumference of the filter 30, in other embodiments the apertures 34 may be disposed in any location on the filter 30 to provide the identified fluid communication between the first and second chambers 31 and 37, respectively.

With reference to FIGS. 1, 3 and 15, the filter 30 may further optionally include fins 36 in its interior. The fins 36 may be ridge-like structures that originate along the inner periphery of the walls 30a (FIG. 15) of the filter 30. The fins 36 may extend in a generally vertical direction along the walls 30a of the filter 30, and may be contoured along the domed sides to reach a specified height within the filter 30 (see also FIG. 1). Other shapes or configurations of fins 36 may also be suitable. Also, while four fins 36 are shown in FIG. 2, in other embodiments another number of fins 36 may be possible.

In an embodiment, the fins 36 may be operable to assist in preventing excess movement of fruits or other infusion substances 95 when they are placed into the chamber 31 and/or when the infusion substance 95 is in the process of being extracted as the cap 20 is tightened onto the body 50. Additionally, the fins 36 may provide further surface area to assist in the extraction. The fins 36 may otherwise act as additional structural protrusions configured to assist in extracting liquid from the infusion substances as the cap 20 is secured onto the lower portion 52 of body 50. That is, as the cap 20 is twisted onto the body 50, the infusion substance 95 is biased rotationally by the twisting of the cap 20 until it comes into contact with the fins 36 which interferes with the rotation of the infusion substance 95. Continued rotation of the cap 50 causes the infusion substance 95 to chop or tear apart by the fins 36 obstructing its motion and narrowing its space within the first chamber 31.

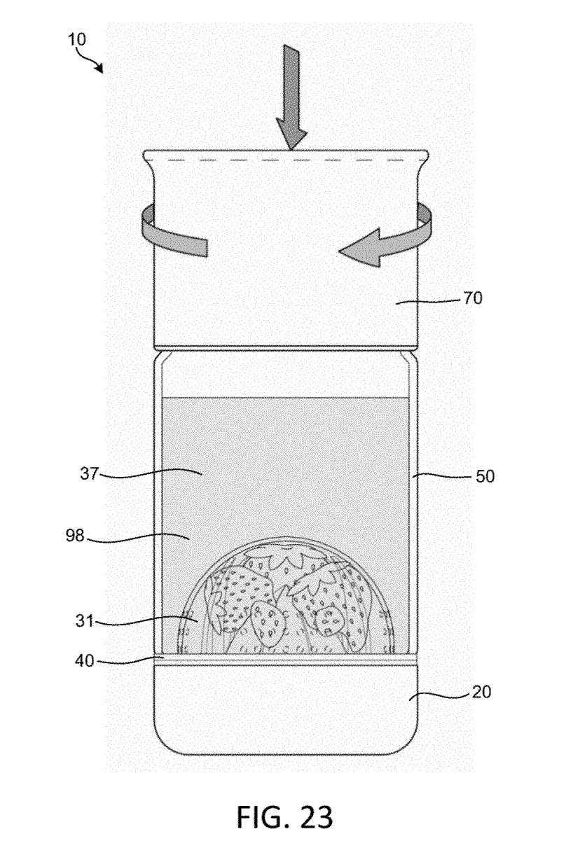

In an embodiment, filter 30 may act as a separating barrier between itself and body 50 (FIGS. 1, 3). As shown in FIG. 22, filter 30 may be configured to prevent excessively large solid particles of the infusion substances from entering into body 50 and thus being undesirably accessible to the user. More specifically, when filter 30 is inserted into body 50 and an infusion substance 95 is present in filter 30 (or added after filter 30 is inserted into body 50), and cap 20 with extractor 24 is thereafter secured to body 50, the filter 30 prevents large particles in its chamber 31 from migrating into the second chamber 37 of infuser 10 used for adding liquid 96 and drinking the resulting blended beverage 98 (FIG. 23). Instead, the filter 30 allows principally fluid interactions between the extracted liquid 93 (shown by the arrows in FIG. 22) in the chamber 31 and a liquid 96 added to the second chamber 37 of infuser 10.

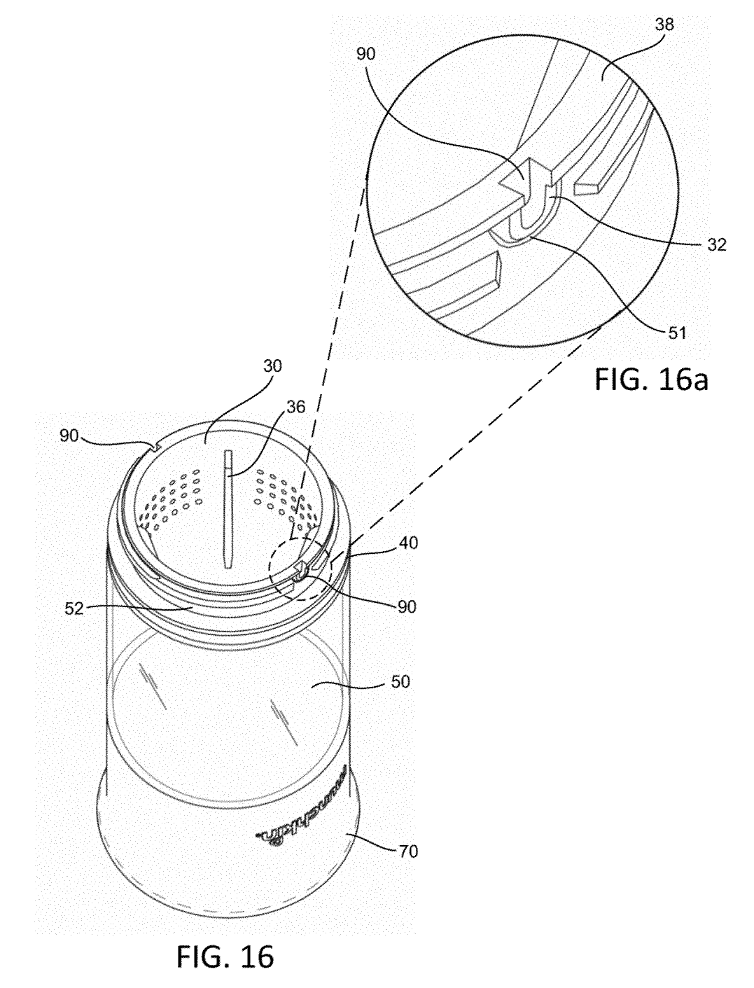

With reference again to FIG. 2, filter 30 may have one or more indexing protrusions 32. In an embodiment, filter 30 has two indexing protrusions 32 disposed on opposite sides of ridge 38 of filter 30 (see, e.g., FIG. 16a). An indexing protrusion 32 of filter 30 is configured to mate with a corresponding indexing gap 51 arranged on the lower portion 52 of body 50 such that the filter 30 can properly align with the body 50 when the filter 30 is inserted into the body 50. The indexing protrusions 32 and corresponding gaps 51 also can prevent unwanted rotation of the filter 30 when the cap 20 is rotationally secured onto body 50.

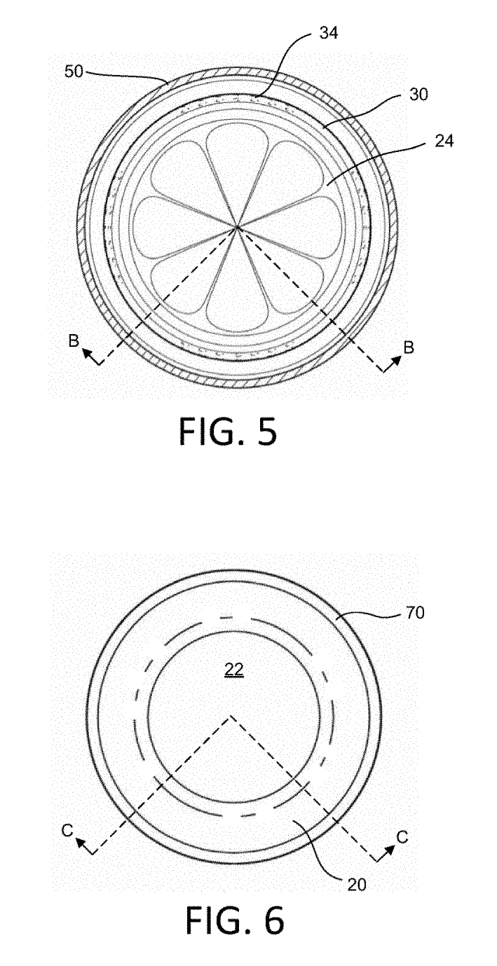

FIG. 7 is a side cross-sectional view taken along lines B-B in FIG. 5 and lines C-C in FIG. 6. Reference to FIG. 6 here is included to establish that the cross-sectional view of FIG. 7 includes the collar and seal assembly 70 omitted from FIG. 5. In the exemplary embodiment of FIG. 7, the infuser 10 is installed together as a single unit. FIG. 8 is a side cross-sectional view taken along lines B-B in FIG. 5 and lines C-C in FIG. 6, according to another embodiment. The configurations in FIGS. 7 and 8 are substantially identical but for certain features to be identified in the collar and seal assembly 70.

Collective reference is initially made to the lower portions of FIGS. 7 and 8. A cross-sectional view of extractor 24 is shown. Extractor 24 may be disposed on cap 20, with cap 20 currently being secured at the bottom of infuser 10. In some embodiments, extractor 24 is an integral member with cap 20. In other embodiments, extractor 24 can be a separate member which can be fixably attached to cap 20 while in operation, and subsequently removed from cap 20 for cleaning or another purpose.

As shown, the extractor 24 may be a citrus juicer. The cap 20 may also have a mating fastening mechanism (e.g., threads) 22 (FIG. 2) that mates with the complementary lower fastening mechanism 54 disposed on the lower portion 52 of the body 50. For example, FIGS. 7-8 show a cross-sectional view of threads 54 of lower portion 52 that are mated with complementary threads 22 on cap 20. Filter 30 is also seen in FIGS. 7-8 with ridge 38 sandwiched between lower portion 52 on one hand and cap 20 on the other hand. Two fins 36 are also visible in this view.

While cap 20 is closed in the views of FIGS. 7-8, it will be appreciated that, as cap 20 is twisted onto threads 54 of lower portion 52, this twisting action can result in both a translational and rotational motion of extractor 24. Accordingly, contemporaneous with the twisting action of securing cap 20 onto the infuser 10, the extractor performs work to mash an infusion substance 95 present in the first chamber 31 of filter 30.

While the fastening mechanisms discussed above for cap 20 and lower portion 52 include threads, other fasteners may be possible. For example, different clamps, screws, seals, and other fastening devices that enable the extractor to apply a force on an infusion substance in the filter 30 concurrent at least in part with the cap 20 being attached to lower portion 52 may be equally suitable.

As shown in FIGS. 7-8, the cap 20 can be substantially hollow to reduce the amount of material needed to manufacture cap 20 in high quantities. However, it is to be understood that the cap 20 may take any density that suitably allows coverage and function as a cap 20 to prevent leakage and to sustain the necessary forces applied to it when it is secured to the body 50.

Referring to FIG. 7, the main portion 59 of body 50 includes upper portion 56, as described herein. As shown in the cross-sectional view of the upper portion 56 and collar and seal assembly 70, the upper portion 56 of body 50 includes an upper fastening mechanism 58 for enabling attachment to collar body 77. In the embodiment shown, the upper fastening mechanism 58 of upper portion 56 includes a plurality of threads 58 which can be mated with a plurality of complementary threads 71 located inside collar body 77.

A cross sectional view of the upper sealing ring 60 is also shown in FIG. 7, although without a pull tab in this embodiment.

Further shown is cross sectional view of projection 72 mated with a correspondingly-shaped recess 72a on seal 80. In the embodiment of FIG. 7, the projection 72 is integrally formed with seal 80. That is, the projection 72 is permanently coupled to the upper wall 73 of collar body 77. Thus, along with apertures 74, projection 72 and upper wall 73 can be built as one integrated unit with the remainder of collar body 77. In other embodiments, collar body 77 may be built using multiple discrete elements.

FIG. 7 further shows that, when pull tab 82 is used, the seal can be removed to expose the upper surface 73a of upper wall 73 of collar body 77.

An infused beverage can be consumed as the juice or other infused liquid 96 can flow in the spaces 78 between the vertical ridges 76 to upper edge 79 as a user drinks by applying suction to a portion of the edge 79 and an adjacent portion of the seal 80 overlying the edge 79. Thus the fluid channels 74 enable flow of the liquid between the body 50 of infuser 10 and the upper surface 23a of collar body 77 to channel the beverage 98 to the user. In addition, the collar and seal assembly 70 may be removed for the purpose of adding water 96 or another liquid to blend with the extracted liquid 93.

In an embodiment, the collar and seal assembly 70 described above enables the liquid in infuser 10 to be contained in infuser 10 in the accidental case where the infuser is dropped or falls onto its side. For example, if a child drinking from infuser 10 drops infuser 10, the drinking action (and thus the suction) stops, and the portion of the seal 80 opened by the drinking action immediately closes over the upper surface 73, thereby containing additional liquid from spilling out of infuser 10 as it is dropped.

Referring to FIG. 8, an embodiment similar to the embodiment of FIG. 7 is shown. The embodiment of FIG. 8 further includes pull tab 62 (as previously described) to facilitate easy removal of upper sealing ring 60, e.g., for purposes of cleaning the unit. In addition, unlike the embodiment of FIG. 7, projection 72 is formed as a separate member that fits into the sides of the upper wall 73 of collar body 77.

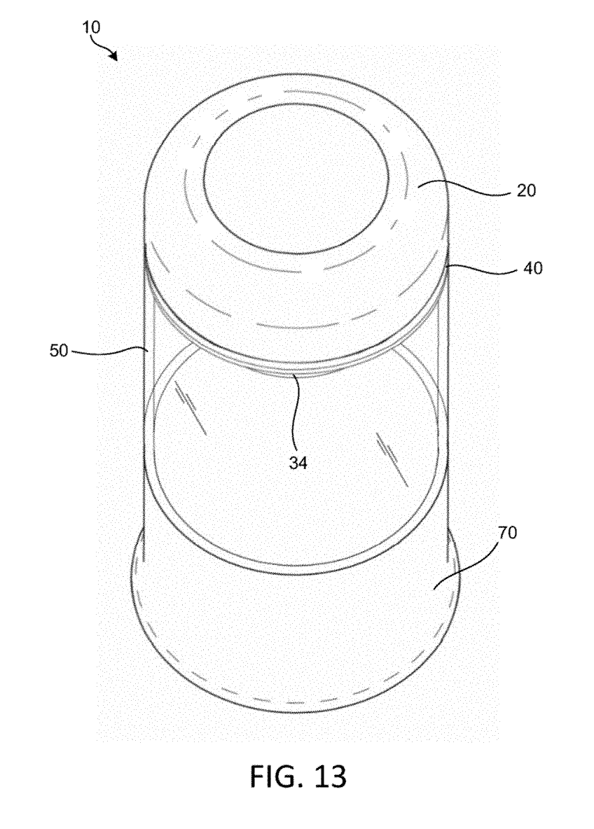

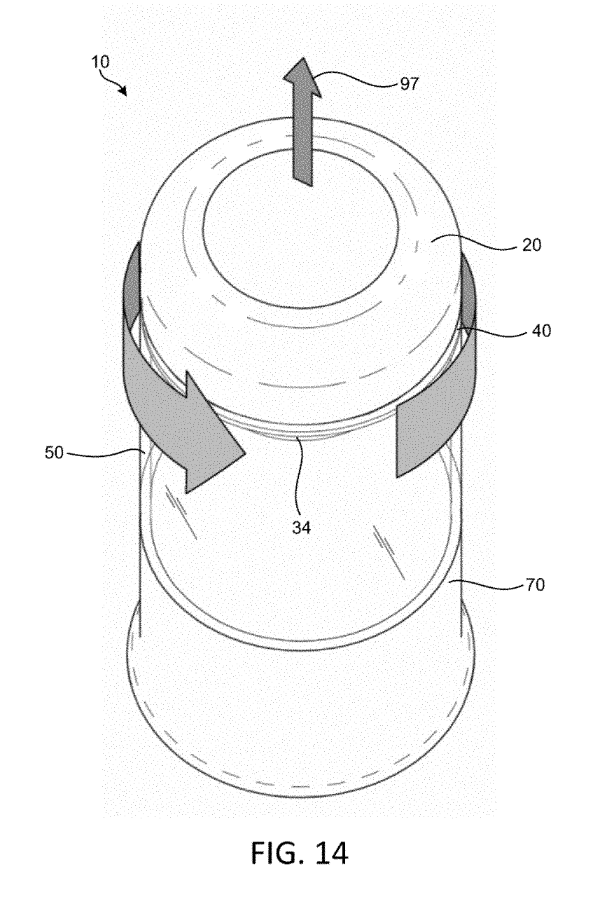

To operate infuser 10, it can be first assumed that infuser 10 is empty and closed, and that all its elements are initially fastened together as a single unit, such as shown in FIGS. 1, 3, 7, 8, etc. This assumption is not mandatory, for example, as the infusion process may start at any arbitrary point in practice. Nevertheless, as a starting point, a user may position the container in an inverted manner similar to FIG. 13, wherein a base 39b of infuser 10 faces in an upward position and the drinking end 39a of infuser 10 faces a downward portion such as being positioned on a surface. At or near the beginning of the infusion process, infuser 10 may be placed in a first position such that cap 20 faces at least partly upward. That is, in the first position, infuser 10 may, but need not, be precisely vertical. For example, the first position may include infuser 10 tilting at an angle relative to a longitudinal direction 97 (FIG. 14) of infuser 10. Thus the first position can be sufficient to enable the cap 20 to face at least partly upward such that a user can remove cap 20 to insert an infusion substance 95 into infuser 10 as contemplated herein. In other embodiments, infuser 10 may be arranged in alternative and equally suitable positions.

FIG. 14 is an upper perspective view of an example of the cap 20 being removed from the infuser 10. FIG. 14 shows a rotational arrow and a vertical arrow. In an embodiment, a user may unfasten, and thereupon remove, the cap 20 from the first or lower portion 52 of body 50, e.g., by screwing the cap off in a counter-clockwise direction or in alternative embodiments, by any other suitable means.

FIG. 15 is an upper perspective view of an exemplary first step of a filter 30 being installed into a first or lower portion 52 of the infuser 10 in accordance with an aspect of the disclosure. The first or lower portion 52 of the infuser 10 in this embodiment includes body 50, collar and seal assembly 70 secured onto body 50 as further described herein, and lower sealing ring 40 installed onto the lower portion 52 of body 50. A pair of indexing gaps 51 may be included on lower portion 52 of body 50. The indexing gaps 51 may be disposed on opposite sides of the lower portion 52 and are designed in this embodiment to mate with corresponding indexing protrusions 32 located on opposite sides of ridge 38 of filter 30. While a pair of such indexing gaps 51 and respective indexing protrusions 32 are used in this example, another number of such features may be used to accomplish a similar purpose. In addition, while the embodiment in FIG. 15 describes the actions taking place relative to a lower portion 52 of the body, the user of the lower portion 52 is exemplary in nature and it should be understood that the filter 30 may be installed on another portion of body 50 or of infuser 10 without departing from the scope of the disclosure.

The vertical arrow in FIG. 15 is present to demonstrate that a user can install the filter 30 onto the lower portion 52 by aligning the indexing protrusions 32 with the respective indexing gaps 51. The mating between the indexing gaps 51 and the indexing protrusions 32 assists in preventing unwanted rotational movement of the filter 30 when the cap 20 is installed and/or removed. In still other embodiments, other types of alignment mechanisms may be used, and fasteners may also be used in more sophisticated infuser containers to secure the filter 30 in place relative to the lower portion 52. For example, the filter 34 may be aligned against a specialized sealing ring such that the frictional shear force of the sealing ring impedes unwanted rotation of the filter during cap 20 installation.

FIG. 16 is an upper perspective view of a second exemplary step of the filter 30 being installed into position. FIG. 16a is an exploded view of an indexing portion of the structure in FIG. 16. As shown in the exploded view of the encircled region, a filter fastening mechanism 90 in one embodiment denotes a region where the indexing protrusions 32 of filter 30 mate with the respective indexing gaps 51 of the lower portion 52 such that filter 30 is securely connected into place. These filter fastening mechanisms 90 advantageously prevent unwanted rotation of the filter when the cap 20 is secured into place, thereby causing the extractor 24 to simultaneously apply a force to the infusion substance 95. Thus the fastening mechanisms 90 contribute to the extraction process by adding a counter-acting rotational force to the existing force asserted by the extractor 24 due to the user's engaging the cap 20 with the body 50. In alternative embodiments, additional or different structures may be used to implement the filter fastening mechanism 90.

In the embodiments of FIGS. 15 and 16, it will be appreciated that filter 30 is already present underneath the cap 20 after the cap 20 is removed. FIG. 15, which demonstrates insertion of the filter 30, may be unnecessary in these embodiments. FIGS. 15 and 16 are nevertheless intended to demonstrate the functional and physical positioning of the filter 30 in certain embodiments, the filter's 30 relationship with adjacent components in certain embodiments, and the securing of the filter 30 to achieve an anti-rotational function. In other embodiments as noted, the filter 30 may need to be inserted after the cap 20 is removed. These techniques of rotationally securing the filter 30 with the body 50 are in contrast to conventional approaches where, for example, poorly fitted filters rotate upon application of an extraction force, or where loosely fitted extractor structures rotate when a user attempts an extraction. The latter example may arise in cases where a user applies a fruit such as a lemon or orange half to a sharp portion of an extractor element, and then rotates the fruit over the extractor element to attempt to extract juice. Where the extractor element is not adequately secured to the container as is conventionally the case, the extractor element typically rotates in the same direction as the user's hand. This rotation of the extractor reduces the rotational force applied by the user, which in turn, reduces the effectiveness of the extraction. Where the extraction is performed by hand, a much stronger force typically need usually be applied in these conventional systems to counteract the performance degradation associated with loose extractors and filters. These shortcomings are addressed in the present disclosure by securing the filter via filter fastening mechanism 90 in FIGS. 16/16a as described above.

In still other embodiments, the filter 30 may be integrated with the lower portion 52 or may be structurally distinct from the filter 30 shown. For example, filter 30 need not have a dome shape, and other shapes are possible.

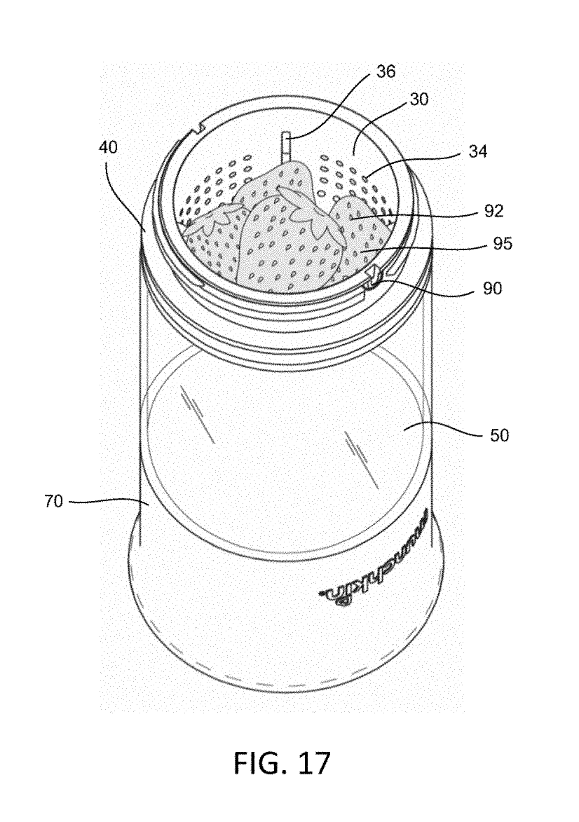

FIG. 17 is an upper perspective view of the infuser 10 with fruit in the filter. The view in FIG. 17 is substantially similar to that of FIG. 16, except that, after installing the filter 30 in place, a user disposes an infusion substance 95 in the filter 30. The exemplary infusion substance 95 in this embodiment includes strawberries 92. Also seen in both FIGS. 16 and 17 are portions of fins 36.

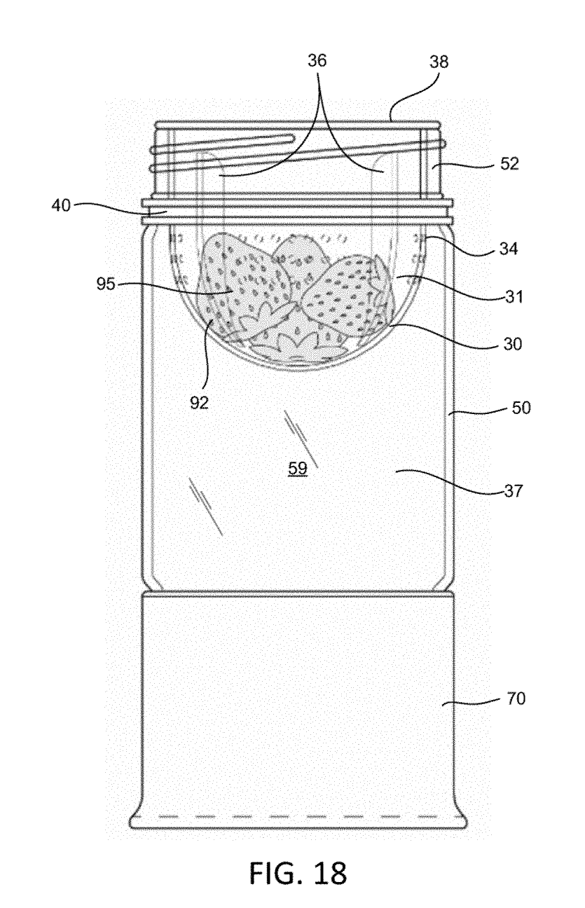

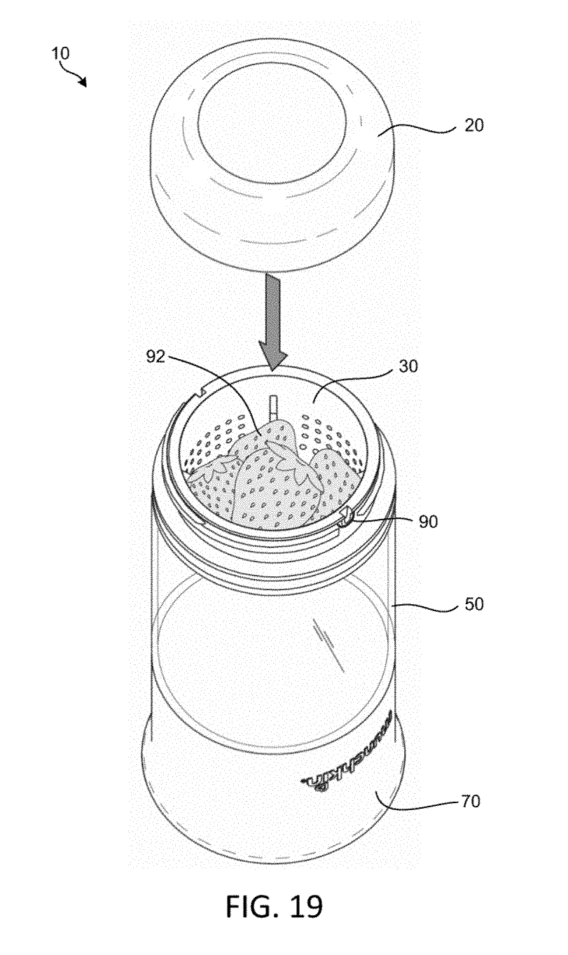

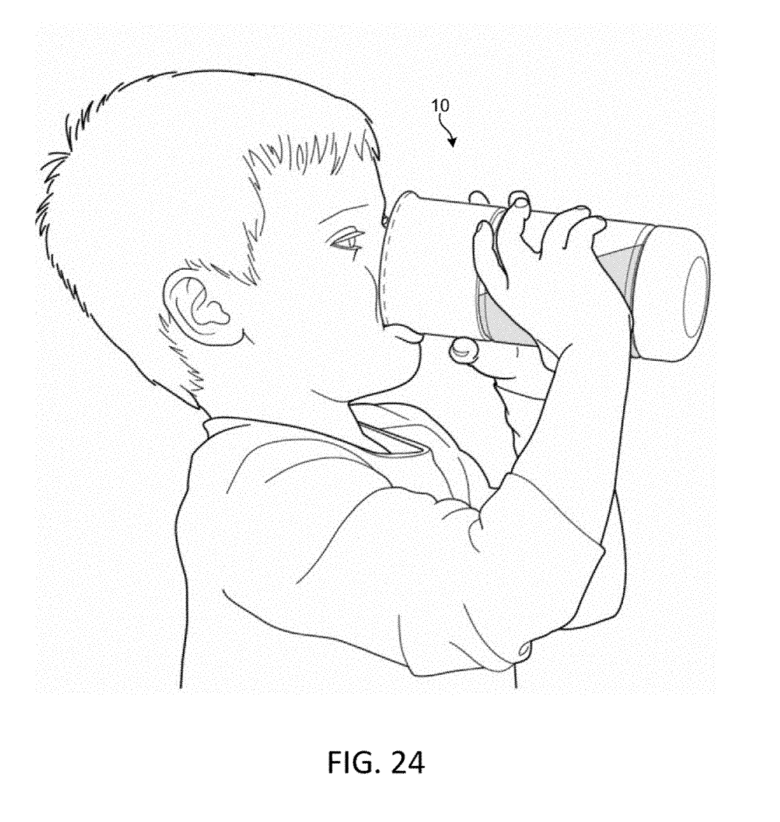

FIG. 18 is a side view of the infuser 10 of FIG. 17. The infuser 10 shows two fins 36 as they extend along walls 30a of the filter 30. The lower sealing ring 40 is also seated in position adjacent main portion 59 of body 50, with collar and seal assembly 70 in place and currently positioned such that the drinking end 39a is facing downward. As noted above, other orientations of infuser 10 are possible depending on the arrangement of its constituent elements, and remain within the scope of the present disclosure. In the embodiment shown, the strawberries 92 are disposed in interior first chamber 31 of filter 30 and are nested next to arrays of apertures 34 in the walls of filter 30. As shown in greater detail below, the apertures enable liquid 93 extracted from the strawberries 92 or other infusion substance to exit the filter and enter the second chamber 37 upon the extracted liquid 93 successfully reaching the apertures, while the apertures 34 act as a barrier to larger items or portions of the infusion substance 95. The size of the apertures 34, and their number and positioning may vary depending on the application. For example, where the infuser 10 is used to make iced tea, the apertures 34 may be made small enough to prevent many or most of the tea leaves from exiting the filter 30. Conversely, where the infuser 10 is used to make juice, the apertures 34 may be made bigger and/or more apertures 34 may be used to enable some pulp to transfer to the body 50. In an embodiment, an infuser 10 includes a variety of filters having different aperture matrices to accommodate different beverages. For example, in the embodiment described in FIGS. 2, 7 and 8, a double filter mechanism is used such that the extracted liquid/substance 93 is first filtered when it passes through apertures 34, and filtered a second time when it passes through apertures fluid channels 74 prior to the blended beverage 98 being consumed (FIGS. 23-24). In this embodiment, respective diameters of the apertures 34 and fluid channels 74 can be arranged accordingly to complement each other.

While the infuser 10, filter 30, fins 36 and other elements thereof are presented herein for purposes of illustration, it will be appreciated by those skilled in the art upon perusal of this disclosure that different configurations, shapes and geometries of the various structures may be equally suitable. For example, filter 30 may take on different shapes and may be included with the lower portion 52 as an integrated unit.

FIG. 19 is an upper perspective view of the cap 20 being attached to the body 50 of the infuser 10. More specifically, in the embodiment shown, the cap 20 is attached to a first or lower portion 52 of the body 50. This step may be performed after the infusion substance 95 is inserted into the filter 30. In FIG. 19, collar and seal assembly 70 remains in the inverted position. A more detailed view of cap 20 is shown in FIG. 2. Cap 20 in FIG. 2 may include, more specifically, extractor 24. While extractor 24 is integrated with cap 20 in this embodiment, in other embodiments extractor 24 may be a separate structure, e.g., that is inserted into an interior of cap 20. The downward vertical arrow in FIG. 19 is intended to specify that the user begins the process of securing the cap 20 by placing it over the inverted lower portion 52 of the infuser 10.

As discussed above, a purpose of extractor 24 is to liquefy portions of the infusion substance 95 present in the first chamber 31 of the filter 30, which extracted liquid 93 can then be provided to the second chamber 37 via apertures 34. The extractor 24 may include a plurality of plastic, metallic, composite, or other symmetrical “leaf-like” or pointed-teardrop elements 24a (FIGS. 2, 3) that extend around an inner circumference or perimeter of cap 20 and that are raised to meet at a point-like area 24b (FIG. 3) generally located at a radial center of cap 20. In an embodiment, the leaf-like elements 24a have sharp sides. The angles of the leaf-like elements 24a relative to the infusion substance 95, the inclined gradient of the elements 24a, and their sharp corners collectively enable the extractor 24, with assistance from fins 36 of filter 30, to mash the infusion substance 95 into a partially liquefied form when the cap 20 is fastened to the body 50.

Referring still to FIG. 2, cap 20 includes a plurality of threads 22 that are complementary in geometrical structure to the threads 54 of lower portion 52 and that consequently enable cap 20 to fasten to the body 50 as described herein. With reference to FIG. 5 in which a top down view of the infuser 10 is shown without a collar and seal assembly 70, an upper view of extractor 24 is shown. Filter 30 with apertures 34 is also shown bordering the extractor 24.

FIG. 20 is a side view of the cap 20 being fastened onto the body 50 of infuser 10. The rotational arrow in FIG. 20 depicts the action of a user fastening the cap 20 onto the lower portion 52 of body 50. In the embodiment shown, the fastening mechanism may include complementary sets of threads 54 and 22. As the cap 20 is twisted onto the body 50, the twisting action causes both rotational and translational motion of the extractor 24. Thus, contemporaneous with the fastening of the cap 20 onto infuser 10, the infusion substance 95 is mashed by the extractor 24 and portions thereof are liquefied to produce an extracted liquid 93. In an exemplary embodiment, as the cap 20 is applied onto the body 50 of infuser 10 and the extractor 24 simultaneously mashes the infusion substance 95, gravity causes the extracted liquid 93 or juice to collect at the bottom of the filter.

In the example of FIG. 20, the cap 20 has just been secured onto the body 50 of infuser 10. The apertures 34 extend generally from near the cylindrical base at ridge 38 (used as an exemplary reference point) to a distance H1, which represents the critical level for mixing. In the example shown, the infusion substance 95 occupies an appreciable portion of the capacity of the first chamber 31 of the filter 30 and the extractor 24 now protrudes down into a portion of the filter 30 to a final stopping point after mashing the infusion substance 95. The extracted liquid 93 has risen to a level of H2 (the liquid flow level) from ridge 38. Because H2>H1, the extracted liquid 93 does not reach the apertures 34 and thus remains in the first chamber 31. The distance H3 represents the total capacity of the filter 30. Depending on the type of infuser 10, the properties of the expected infusion substances 95 to be used, and other factors, the filter 30 may be designed with specific values of H1 and H3 to enable an extracted liquid to remain at a level such that H2>H1, thereby discouraging liquid flow from filter 34 at the extraction stage, in embodiments where such feature is desirable.

It should be noted that if additional extracted liquid 93 is desired for a more concentrated infusion, the user may elect to unscrew cap 20, rearrange the contents of the infusion substance 95, and repeat the mashing process. However, in an exemplary embodiment, the unscrewing of the cap 20 may allow for further mashing without having to remove the cap 20 from the body 50. That is, cap 20 can be loosened and retightened one or more times as desired, which causes the mashing and re-mashing of the pulp to occur. This process of loosening and tightening the cap 20 without entirely unscrewing the cap 20 can be repeated one or more times by the user to further mash the pulp or infusion substance 95 until a desired texture is obtained. In an embodiment, the fins 36 are oriented to facilitate the mashing process along with the extractor 24. For example, during the engaging and reengaging of the body 20 via the loosening and re-tightening process described above, the fins can rotationally bias the infusion substance 95 and provide added surface area during each separate mashing or re-mashing process. In other embodiments, a single act of engaging the cap 20 with the body 50 may be sufficient to mash the pulp to the desired texture, such that the multiple engaging and re-engaging of the cap 20 with the body 50 is rendered unnecessary.

In sum, and in contrast to existing approaches, the extracted liquid 93 is preserved in the first chamber 31 of the filter 30 by designing the apertures 34 in a manner such that the extracted liquid 93 remains in the filter 30 and does not leak into the second chamber of the body 50 due to gravity. This feature is in contrast to conventional approaches, in which once liquid is extracted, the liquid falls to the drinking side of the container and leaves an unwanted residue, causing sticky inconsistencies in the infusion process and often compromising the quality of the beverage. In the embodiment of FIG. 20, by contrast, the extracted liquid remains preserved in the filter 30 until further steps are taken. Using the principles described in this disclosure, an infuser 10 can be designed to accommodate a variety of different infusion substances 95 based on the type of substance, the volume of the filter cavity before and after entry by the extractor 24, and other relevant variables that minimize or prevent altogether the overspill of the extracted liquid 93 while the infuser 10 is inverted.

It should be understood that, while the various embodiments shown demonstrate that a portion, a majority, or all of the extracted liquid in the filter chamber can be preserved in the filter 30 while the infuser 10 is inverted, in other embodiments this feature need not be present.

FIG. 21 illustrates a perspective view of infuser 10 after the collar and seal assembly 70 is removed. Liquid 96 can be added by the user into the second chamber 37. The added and extracted liquids 96 and 93 are generally free to move bi-directionally between the first and second chambers as the fluids are blended together.

FIG. 22 is an upper perspective view of the liquid 93 added into the second chamber 37 of infuser 10. Assuming the liquid 96 is a low viscosity substance such as water, the liquid 96 will immediately flow to the bottom of the container and may flow through the apertures 34 and “meet” the extracted liquid 93. In contrast to existing infuser approaches, wherein often the extracted liquid is arbitrarily distributed in the reservoir or potentially worse, concentrated near the drinking end during the extraction process, the extracted liquid 93 can be configured to gradually blend with the added liquid 96, such that the resulting solution is more uniform and less messy. In FIG. 22, the rotational arrows show the flow of the liquid 96 and the extracted liquid 93. In various embodiments, the concentration of the liquid 96 will gradually change as it circulates through the filter 30 and/or blends directly with the extracted liquid 93. Further, more of the extracted liquid 93 is preserved to be blended, since portions of it were not left as residue on the inner surface of the drinking end 39a as in many conventional devices.

FIG. 23 is a side view of the infuser 10 with the blended liquid 98 and the cap 20 secured back onto infuser 10.

While the embodiments above describe numerous advantages of the disclosed infuser over conventional devices, it should be understood that in some embodiments some or many of these features may be omitted. One significant advantage of the infuser 10 as disclosed is that because the extraction process is at least partially concurrent with the fastening of the cap 30, an entire step in the infusion process can be eliminated, which can significantly increase the efficiency of the infusion process.

FIG. 24 is a view of the infuser 10 in use. A user can drink from the container in the manner described in further detail above. As noted with reference to FIGS. 2, 7 and 8, because the seal 80 may close over the upper surface 73a of the collar body as soon as the drinking action discontinues, accidental spills or leaks are significantly reduced or eliminated. Conventional containers, by contrast, often result in spills and leaks, and require a separate juicer and container, unlike the integrated, usable unit as disclosed herein.

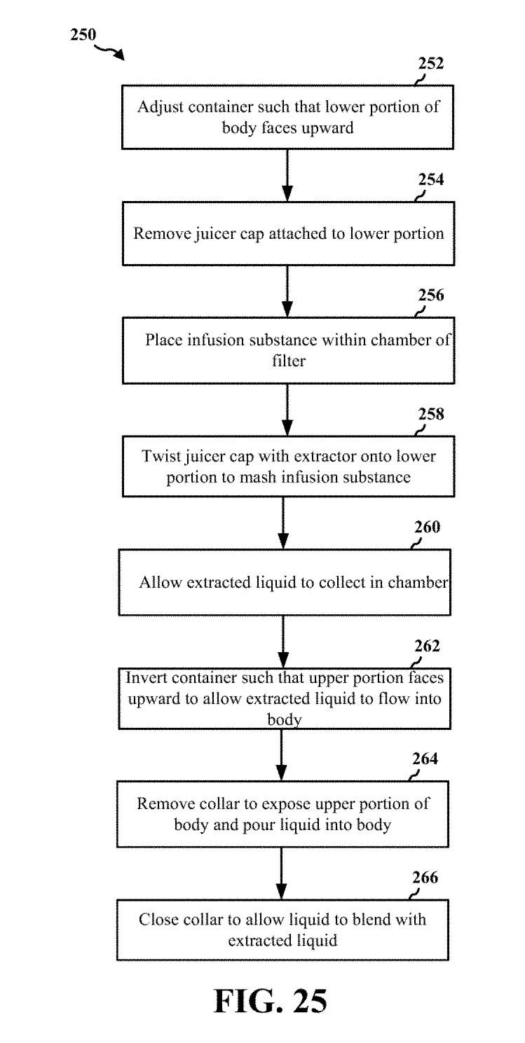

FIG. 25 is a flow diagram 250 of an exemplary method of creating a beverage using the infuser container.

FIG. 25 shows step 252, in which the container is adjusted such that the first (e.g., lower) portion of the body faces upward. The positioning of the infuser 10 as described in this exemplary step is illustrated in FIG. 13.

FIG. 25 shows step 254, in which the cap 20 may be removed from the first or lower portion 52 of body 20. An example of the removal step is shown in FIG. 14, described above.

FIG. 25 shows step 256, in which a user places an infusion substance within a chamber of the filter. An example of this step is shown in FIG. 17, described above. The step 256 of FIG. 25 results in the exemplary depiction of FIG. 17 with the infusion substance 95 including strawberries 92.

FIG. 25 shows step 258, in which the cap 20 is twisted onto lower portion 52 of body 50 to cause the extractor 24 to mash the infusion substance. This step is illustrated in FIG. 20, described above. In various embodiments where additional extraction is desired (e.g. for a particular infusion substance 95 whose properties may require it), cap 20 can be removed and reinserted one or more times until the desired amount of liquid is extracted.

FIG. 25 shows step 260, in which the desired amount of extracted liquid is permitted to collect in the chamber of filter 30.

FIG. 25 shows step 262, in which the user inverts the container such that the drinking end 39a and upper portion 56 face upward to allow the extracted liquid 93 or substance to flow into the second chamber 37 of the body 50. In this step, which is illustrated in FIG. 21, rather than rushing to the drinking end of the infuser 10, the extracted liquid may 95 may instead remain in large part (and depending on its viscosity) trapped in the upper dome-like portion of the filter at or above level 93, and impeded by the extractor 24, the fins 36 and the remaining infusion substance, the extracted liquid 95 may be initially stagnant and slow to flow towards the filter base, as shown. In this example, the extracted liquid 95 from the strawberries has for the most part not yet reached the apertures 34.

FIG. 25 shows step 264, in which the user may remove the collar and seal assembly 70 to add water or another liquid 96 to the body 50. This step is also shown in FIG. 21, where the vertical arrow shows that the collar and seal assembly 70 has been removed.

In step 266 of FIG. 25, the user can close the collar and seal assembly 70 to allow blending or to consume the blended beverage 98. In FIG. 23, the collar assembly 77 is refastened to the infuser 10. In the embodiment shown as indicated by the down and rotational arrow, the collar and seal assembly 70 is reinserted onto the upper portion 58 of body 50. The liquids in this example have blended and the infusion is complete. It is noted that the liquids have saturated in the filter 30 and the concentration of the infusion can be made substantially uniform and without residue as described above.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other types of structures beyond juicers. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A beverage container comprising:
a body;
a filter arranged with the body to form a first chamber for receiving an infusion substance and a second chamber; and
a cap engaged with the body, the cap having an extractor extending into the first chamber when the cap is engaged with the body;
wherein the engaging of the cap with the body causes the extractor to produce an extracted liquid.

2. The container of claim 1, wherein when the cap is engaged with the body while the container is inverted, the filter collects the extracted liquid in the first chamber and prevents flow of the extracted liquid to the second chamber.

3. The container of claim 2, wherein the filter prevents the flow of the extracted liquid to the second chamber up to a predetermined extracted liquid level.

4. The container of claim 1, wherein when engaging the cap with the body, the filter is prevented from rotating relative to the body.

5. The container of claim 4, wherein the filter comprises at least one indexing feature that mates with a corresponding feature on the body to prevent the rotating.

6. The container of claim 1, wherein the filter further comprises a plurality of fins arranged in the first chamber.

7. The container of claim 1, wherein the filter comprises at least one fin arranged in the first chamber.

8. The container of claim 7, wherein the at least one fin is oriented to rotationally bias the infusion substance when the cap is engaged with the body.

9. The container of claim 1, wherein the extractor mashes the infusion substance to a desired texture when the cap is engaged with and loosened from the body one or more times without removing the cap from the body.

10. The container of claim 1, wherein the filter is configured to enable the extracted liquid to enter the second chamber when the container is changed from an inverted to a non-inverted position after the cap is engaged with the body.

11. The container of claim 1, further comprising a collar and seal assembly configured to seal the second chamber.

12. The container of claim 11, wherein the collar and seal assembly comprises a second filter for filtering liquid exiting the collar and seal assembly for consumption.

13. The container of claim 11, wherein the collar and seal assembly further comprises:
a surface having an edge; and
a seal arranged on the surface adjacent the edge,
wherein a suction force applied to adjacent portions of the seal and the edge causes the seal to open sufficient to enable a user to drink from the container.

14. The container of claim 13, wherein the seal closes upon termination of the suction force.

15. A beverage container comprising:
a body;
a filter arranged with the body to form a first chamber for receiving an infusion substance and a second chamber; and
a cap engaged with the body, the cap having an extractor extending into the first chamber when the cap is engaged with the body;
wherein the extractor mashes the infusion substance to produce an extracted substance when engaging the cap with the body.

16. The container of claim 15, wherein the engaging of the cap onto the body causes the extractor to apply a force to the received infusion substance.

17. The container of claim 15, further comprising a collar and seal assembly configured to seal the second chamber.

18. The container of claim 15, wherein the extractor mashes the infusion substance to provide a desired texture to the extracted substance by engaging the cap with the body one or more times without removing the cap from the body.

19. A method of making a liquid infused beverage comprising:
positioning a container in a first position such that a cap faces at least partly upward, a filter arranged with a body of the container to form a first chamber for receiving an infusion substance and a second chamber, the cap having an extractor extending into the first chamber when the cap is engaged with the body;
inserting an infusion substance into the first chamber; and
engaging the cap onto the body which concurrently mashes the infusion substance and extracts a liquid therefrom.

20. The method of claim 19, wherein the engaging the cap onto the body comprises twisting the cap onto threads of a first portion of the body to move the extractor.
